(19) United States
(12) Patent Application Publication
(10) Pub. No.: US 2021/0287286 A1
(43) Pub. Date: Sep. 16, 2021

(54) INFORMATION PROCESSING METHOD, COMPUTER-READABLE NON-TEMPORARY STORAGE MEDIUM STORING PROGRAM, AND INFORMATION PROCESSING DEVICE

(71) Applicant: MERCARI, INC., Tokyo (JP)

(72) Inventor: Keita NAKAMURA, Tokyo (JP)

(21) Appl. No.: 17/200,485

(22) Filed: Mar. 12, 2021

(30) Foreign Application Priority Data
Mar. 16, 2020 (JP) 2020-044898

(51) Int. Cl. G06Q 40/02; G06Q 30/06

(52) U.S. Cl. CPC G06Q 40/025; G06Q 30/0635

(57) ABSTRACT

An information processing method, a computer-readable non-temporary storage medium storing a program, and an information processing device that are capable of achieving a system configured to allow more flexible debt repayment by postponing a debt repayment day and providing a loan based on listing on an electronic trade platform are provided. In an information processing method executed by an information processing device including one or a plurality of processors, the one or plurality of processors execute processing of acquiring a listing request for a listed item from a first information processing device used by a first user; processing of listing the listed item; and processing of permitting delay of repayment of a debt associated with the first user based on a listed price or market price of the listed item.

### CROSS REFERENCE TO RELATED APPLICATION

This application claims priority to Japanese Patent Application No. 2020-044898, filed with the Japanese Patent Office on Mar. 16, 2020, entitled “INFORMATION PROCESSING METHOD, COMPUTER-READABLE NON-TEMPORARY STORAGE MEDIUM STORING PROGRAM, AND INFORMATION PROCESSING DEVICE”, which is incorporated herein by reference in its entirety.

### FIELD OF THE INVENTION

The present disclosure relates to an information processing method, a computer-readable non-temporary storage medium storing a program, and an information processing device.

### DESCRIPTION OF THE RELATED ART

Recently, a listed item trade has been performed between individuals through the Internet and a communication line. For example, a listing user registers and lists an item at a predetermined trade platform, and a purchase user requests purchase of the item listed at the predetermined trade platform.

In such an electronic trade, some duration is needed until a listing user receives money since a listed item is listed, and the listing user cannot receive money promptly at or swiftly after the listing. To solve this situation, for example, Japanese Patent Laid-open No. 2001-202469 discloses a technology of providing, when a loan is requested by a seller, a predetermined loan after performing credence inquiry that inquires whether the seller is appropriate as a borrower of the loan based on a record of participation to list and the like.

### SUMMARY OF THE INVENTION

However, a system that supports more flexible debt repayment by using listing on an electronic trade platform has been desired.

Thus, the present disclosure is made in consideration of such circumstances and provide an information processing method, a computer-readable non-temporary storage medium storing a program, and an information processing device that allow more flexible debt repayment through listing on an electronic trade platform.

An information processing method according to an embodiment of the present disclosure is an information processing method executed by an information processing device including one or a plurality of processors, in which the one or plurality of processors execute: processing of acquiring a listing request for a listed item from a first information processing device used by a first user; processing of listing the listed item; and processing of permitting delay of repayment of a debt associated with the first user based on the listed price or market price of the listed item.

An information processing method according to another embodiment of the present disclosure is an information processing method executed by an information processing device including one or a plurality of processors, in which the one or plurality of processors execute: processing of acquiring a listing request for a listed item; processing of listing the listed item from a first information processing device used by a first user; and processing of adding a credit determined based on the listed price or market price of the listed item and a credence score of the first user to a credit total associated with the first user.

### BRIEF DESCRIPTION OF THE DRAWINGS

FIG. 1 is an exemplary block diagram illustrating an exemplary configuration of a trade system according to an aspect of a first embodiment, an exemplary hardware configuration of a server according to a disclosure, an exemplary hardware configuration of a terminal according to the present disclosure, and the configuration of the trade system according to the first embodiment;

FIG. 2 is a diagram for description of a hardware configuration of a server 110B according to the aspect of the first embodiment;

FIG. 3 schematically illustrates the configuration of the trade system according to the first embodiment;

FIG. 4 is a diagram illustrating exemplary user management data stored in a memory of a server 110 according to the first embodiment;

FIG. 5 is a diagram illustrating exemplary trade management data stored in the memory of the server 110 according to the first embodiment;

FIG. 6 is a diagram illustrating exemplary debt management data stored in a memory of the server 110B according to the first embodiment;

FIG. 7 is a diagram illustrating an exemplary sequence of processing by the trade system according to the first embodiment;

FIG. 8 is a diagram illustrating an exemplary sequence of processing according to an example of the first embodiment;

FIG. 9 schematically illustrates the configuration of a trade system according to a second embodiment;

FIG. 10 is an exemplary block diagram illustrating an exemplary configuration of a trade system according to an aspect of the second embodiment, an exemplary hardware configuration of the server according to the disclosure, an exemplary hardware configuration of the terminal according to the present disclosure, and the configuration of the trade system according to the second embodiment;

FIG. 11 is a diagram illustrating exemplary user management data stored in the memory of the server 110 according to the second embodiment;

FIG. 12 is a diagram illustrating exemplary trade management data stored in the memory of the server 110 according to the second embodiment;

FIG. 13 is a diagram illustrating exemplary loan management data stored in the memory of the server 110 according to the second embodiment;

FIG. 14 is a diagram illustrating an exemplary sequence of processing by the trade system according to the second embodiment; and

FIG. 15 illustrates an exemplary sequence of processing according to an example of the second embodiment.

### DETAILED DESCRIPTION OF THE PREFERRED EMBODIMENTS

Law Compliance

Disclosure described in the present specification is performed in compliance with laws of a country where the present disclosure is performed. The disclosure described in the present specification is performed with all kinds of change, replacement, deformation, modification, and correction that are necessary for compliance with laws of the country and could be thought of by the skilled person in the art.

Configurations for achieving a computer-readable non-temporary storage medium in which a program according to the present disclosure is stored, an information processing device, and an information processing method will be described below with reference to the accompanying drawings.

System Configuration

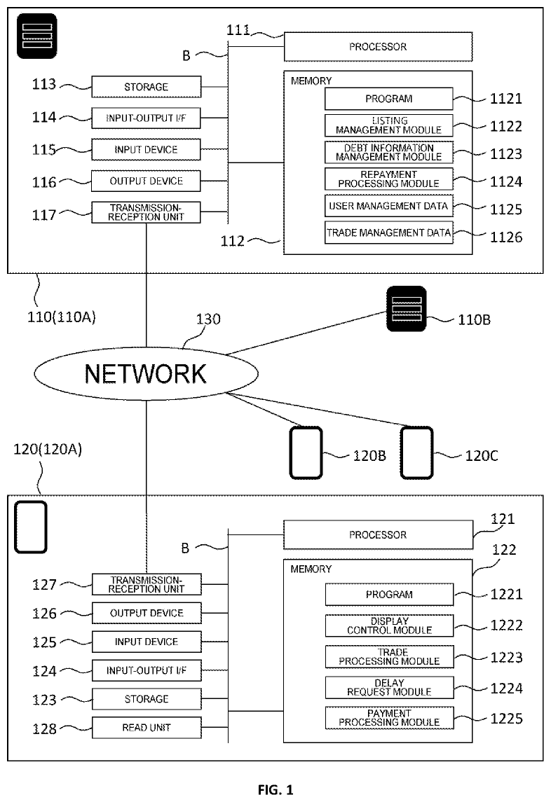

FIG. 1 illustrates the configuration of a trade system 1 for effectively performing an information processing method according to an embodiment of the present disclosure. As disclosed in FIG. 1, in the trade system 1, a server 110A and a server 110B are connected to a terminal 120A, a terminal 120B, and a terminal 120C through a network 130.

In the present disclosure, the servers 110A and 110B may be each referred to as a server 110 when not needed to be distinguished from each other. The number of servers 110 connected to the network 130 is not limited.

In the present disclosure, the terminals 120A, 120B, and 120C may be each referred to as a terminal 120 when not needed to be distinguished from each other. The number of terminals 120 connected to the network 130 is not limited.

In the present disclosure, the server 110 and the terminal 120 may be each referred to as an information processing device 200 when not needed to be distinguished from each other. The number of information processing devices 200 connected to the network 130 is not limited.

The server 110 provides, through the network 130, predetermined services to the terminal 120 used by a user. The predetermined services not restrictively but exemplarily include a payment service, a financial service, an electronic trade service, a social networking service (SNS) such as an instant messaging service, and a provision service of contents such as music, movie, and book. One server 110 may provide one or more predetermined services, or a plurality of servers 110 may provide one or more predetermined services. The predetermined services provided to one or more terminals 120 by each server 110 can be used by each user through the corresponding terminal 120.

In the present disclosure, the payment service includes a service with which one or more users can send and receive money or a money equivalent such as points. The payment service not restrictively but exemplarily includes a service that performs payment by using a one-dimensional code (such as a bar code), a two-dimensional code (such as a QR code (registered trademark)) (hereinafter, a one-dimensional code and a two-dimensional code are collectively referred to as a “two-dimensional code and the like”), or short distance wireless communication (such as near field communication (NFC), Bluetooth (registered trademark) Low Energy (BLE), Wi-Fi (registered trademark), ultrasonic wave communication, or infrared communication). Payment performed as the terminal 120 of a user (payer) who performs the payment reads a two-dimensional code or the like is referred to as “user-reading code payment” or “merchant presented mode (MPM)”. Payment performed as the terminal 120 of a user (seller or demander) of a shop or the like who demands the payment reads a two-dimensional code or the like displayed by the terminal 120 of a user who performs the payment is referred to as “shop-reading code payment” or “consumer presented mode (CPM)”. The MPM and the CPM may be dynamic or static.

When needed, a terminal used by a user X is referred to as a terminal 120X, and information associated with a user in a predetermined service and associated with the user X or the terminal 120X is referred to as user information X. The user information may not restrictively but exemplarily include information associated with the user, such as the name of the user, an icon image of the user, the age of the user, the sex of the user, the address of the user, interest and taste of the user, an identifier of the user, balance information of an electronic value (electronic money) associated with the user, and credit card information (such as a credit card number) associated with the user, which are input by the user or provided by a predetermined service.

The network 130 connects two or more servers 110 or two or more terminals 120. The network 130 provides a connection path through which data can be transmitted and received after the terminal 120 is connected to the server 110.

One or more parts of the network 130 may be a wired network or a wireless network. The network 130 may be not restrictively but exemplarily an ad hoc network, an intranet, an extranet, a virtual private network (VPN), a local area network (LAN), a wireless LAN (WLAN), a wide area network (WAN), a wireless WAN (WWAN), a metropolitan area network (MAN), part of the Internet, part of a public switched telephone network (PSTN), a cellular phone network, an Integrated Services Digital Network (ISDN), a wireless LAN, Long Term Evolution (LTE), Code Division Multiple Access (CDMA), Bluetooth (registered trademark), satellite communication, or a combination thereof. The network 130 may include one or a plurality of networks 130.

The server 110 and the terminal 120 may be any information processing device that can achieve functions and methods written in the present disclosure.

The server 110 and the terminal 120 may be each not restrictively but exemplarily a smartphone, a cellular phone (feature phone), a computer (not restrictively but exemplarily a desktop, a laptop, or a tablet), a server device, a media computer platform (not restrictively but exemplarily a cable, a satellite set-top box, or a digital video recorder), a handheld computer device (not restrictively but exemplarily a personal digital assistant (PDA) or an electronic mail client), a wearable terminal (not restrictively but exemplarily a glass-type device or a clock-type device), any other kind of computer, or a communication platform, or a combination thereof.

Hardware Configuration of Information Processing Device

(1) Hardware Configuration of Server

The following describes a hardware configuration of the server 110 included in the trade system 1 with reference to FIG. 1.

The server 110 includes a processor 111, a memory 112, a storage 113, an input-output interface (input-output I/F) 114, an input device 115, an output device 116, and a transmission-reception unit 117. The hardware components of the server 110 are mutually connected not restrictively but exemplarily through a bus B.

The server 110 achieves processing, a function, or a method written in the present disclosure through cooperation of the processor 111, the memory 112, the storage 113, the input-output I/F 114, and the transmission-reception unit 117.

The processor 111 executes processing, a function, or a method achieved by a code included in a program stored in the storage 113 or by a command. The processor 111 not restrictively but exemplarily includes one or a plurality of central processing units (CPUs), micro processing units (MPUs), graphics processing units (GPUs), microprocessors, processor cores, multiprocessors, application-specific integrated circuits (ASICs), field programmable gate arrays (FPGAs) and may achieve processing, a function, or a method disclosed in each embodiment through a logic circuit (hardware) or dedicated circuit formed on an integrated circuit (IC) (IC chip or large scale integration (LSI)) or the like. These circuits may be achieved by one or a plurality of integrated circuits, and a plurality of pieces of processing described in each embodiment may be achieved by one integrated circuit. An LSI is sometimes referred to as a VLSI, a super LSI, an ultra LSI, or the like, depending on the degree of integration.

The memory 112 temporarily stores a program 1121 loaded from the storage 113 and provides a work area to the processor 111. The memory 112 also temporarily stores various kinds of data generated while the processor 111 executes the program. The memory 112 may be not restrictively but exemplarily a random access memory (RAM), a read only memory (ROM), or a combination of thereof.

The storage 113 stores programs, modules, and various kinds of data. The storage 113 may be not restrictively but exemplarily a hard disk drive (HDD), a solid state drive (SSD), a flash memory, or a combination thereof.

The input-output I/F 114 is connected to the input device 115 through which various operations are input to the server 110 and with the output device 116 from which a processing result processed by the server 110 is output.

The input device 115 is achieved by any of all kinds of devices or a combination thereof capable of receiving an input from the user and transferring information related to the input to the processor 111 through the input-output I/F 114. The input device may be not restrictively but exemplarily a touch panel, a touch display, a hardware key such as a keyboard, a pointing device such as a mouse, a camera (operation input through an image), a microphone (operation input through voice), or a combination thereof.

The output device 116 is achieved by any of all kinds of devices or a combination thereof from which a processing result processed by the processor 111 can be output through the input-output I/F 114. In a case in which the processing result is output as a video or a moving image, the output device 116 is achieved by any of all kinds of devices or a combination thereof capable of displaying, in accordance with display data written to a frame buffer, the display data. The output device 116 may be not restrictively but exemplarily a touch panel, a touch display, a monitor (not restrictively but exemplarily a liquid crystal display or an organic electroluminescence display (OELD)), a head-mounted display (HMD), projection mapping, a hologram, a device capable of displaying an image, text information, and the like in air or the like (including vacuum), a speaker (voice output), a printer, or a combination thereof. These output devices may be capable of displaying display data in 3D.

The input device 115 and the output device 116 may be integrated with or separated from each other.

The transmission-reception unit 117 transmits and receives various kinds of data through the network 130. This communication may be executed in a wired or wireless manner and may employ any communication protocol as long as the communication can be executed. The transmission-reception unit 117 has a function to execute communication with another information processing device through the network 130. The transmission-reception unit 117 transmits various kinds of data to another information processing device in accordance with an instruction from the processor 111. The transmission-reception unit 117 receives various kinds of data transmitted from another information processing device and transfers the data to the processor 111.

(2) Hardware Configuration of Terminal 120

The following describes a hardware configuration of the terminal 120 included in the trade system 1 with reference to FIG. 1.

The terminal 120 includes a processor 121, a memory 122, a storage 123, an input-output I/F 124, an input device 125, an output device 126, and a transmission-reception unit 127. The hardware components of the terminal 120 are not restrictively but exemplarily mutually connected through the bus B.

The terminal 120 achieves processing, a function, or a method written in the present disclosure through cooperation of the processor 121, the memory 122, the storage 123, the input-output I/F 124, the input device 125, the output device 126, and the transmission-reception unit 127.

The processor 121 executes processing, a function, or a method achieved by a code included in a program stored in the storage 123 or by a command. The processor 121 not restrictively but exemplarily includes a central processing unit (CPU), a micro processing unit (MPU), a graphics processing unit (GPU), a microprocessor, a processor core, a multiprocessor, an application-specific integrated circuit (ASIC), a field programmable gate array (FPGA) and may achieve processing, a function, or a method disclosed in each embodiment through a logic circuit (hardware) or a dedicated circuit formed on an integrated circuit (IC) (IC chip or large scale integration (LSI)) or the like. These circuits may be achieved by one or a plurality of integrated circuits, and a plurality of pieces of processing described in each embodiment may be achieved by one integrated circuit. An LSI is sometimes referred to as a VLSI, a super LSI, an ultra LSI, or the like, depending on the degree of integration.

The memory 122 temporarily stores a program 1221 loaded from the storage 123 and provides a work area to the processor 121. The memory 122 also temporarily stores various kinds of data generated while the processor 121 executes the program 1221. The memory 122 may be not restrictively but exemplarily a random access memory (RAM), a read only memory (ROM), or a combination of thereof.

The storage 123 stores programs and various kinds of data. The storage 123 may be not restrictively but exemplarily a hard disk drive (HDD), a solid state drive (SSD), a flash memory, or a combination thereof.

The input-output I/F 124 is connected to the input device 125 through which various operations are input to the terminal 120 and with the output device 126 from which a processing result processed by the terminal 120 is output.

The input device 125 is achieved by any of all kinds of devices or a combination thereof capable of receiving an input from the user and transferring information related to the input to the processor 121. The input device may be not restrictively but exemplarily a touch panel, a touch display, a hardware key such as a keyboard, a pointing device such as a mouse, a camera (operation input through an image), a microphone (operation input through voice), or a combination thereof.

The output device 126 is achieved by any of all kinds of devices or a combination thereof from which a processing result processed by the processor 121 can be output. In a case in which the processing result is output as a video or a moving image, the output device is achieved by any of all kinds of devices or a combination thereof capable of displaying, in accordance with display data written to a frame buffer, the display data. The output device may be not restrictively but exemplarily a touch panel, a touch display, a monitor (not restrictively but exemplarily a liquid crystal display or an organic electroluminescence display (OELD)), a head-mounted display (HMD), projection mapping, a hologram, a device capable of displaying an image, text information, and the like in air or the like (including vacuum), a speaker (voice output), a printer, or a combination thereof. These output devices may be capable of displaying display data in 3D.

The input device 125 and the output device 126 may be integrated with or separated from each other.

The transmission-reception unit 127 transmits and receives various kinds of data through the network 130. This communication may be executed in a wired or wireless manner and may employ any communication protocol as long as the communication can be executed. The transmission-reception unit 127 executes communication with another information processing device through the network 130. The transmission-reception unit 127 transmits various kinds of data to another information processing device in accordance with an instruction from the processor 121. The transmission-reception unit 127 receives various kinds of data transmitted from another information processing device and transfers the data to the processor 121.

(3) Other Configurations

At least part of processing, a function, or a method at the server 110 or the terminal 120 may be achieved by cloud computing configured with one or more information processing devices.

At least part of processing, a function, or a method at the server 110 or the terminal 120 may be achieved by another information processing device. In this case, at least part of processing achieved by the processor 111 or the processor 121 may be achieved by a processor of the other information processing device.

A program configured to execute processing in each embodiment of the present disclosure may be stored and provided in a computer-readable storage medium. The storage medium is a “non-temporary physical medium” capable of storing programs. Each program may be not restrictively but exemplarily a software program or a computer program.

The storage medium may be one or a plurality of semiconductor-based storage media or may be another integrated circuit (IC) (not restrictively but exemplarily a field programmable gate array (FPGA) or an application-specific integrated circuit (ASIC)), a hard disk drive (HDD), a hybrid hard drive (HHD), an optical disk, an optical disk drive (ODD), an magneto-optical disc, a magneto-optical drive, a floppy diskette, a floppy disk drive (FDD), a magnetic tape, a solid state drive (SSD), a RAM drive, a secure digital card or drive, any other optional appropriate storage medium, or a combination thereof. The storage medium may be a volatile storage medium, a non-volatile storage medium, or a combination thereof.

A program of the present disclosure may be provided to the server 110 or the terminal 120 through an optional transmission medium (communication network, broadcast wave, or the like) by which the program can be transmitted.

Each embodiment of the present disclosure may be achieved in the form of data signal as which a program is realized through electronical transmission and that is embedded in carrier wave.

A program of the present disclosure may be not restrictively but exemplarily implemented by using a script language such as JavaScript (registered trademark) or Python, C language, Go language, Swift, Kotlin, Java (registered trademark), or the like.

### <Others>

The configuration of determination in each embodiment of the present disclosure is not essential unless otherwise stated explicitly, and predetermined processing may be operated when a determination condition is satisfied or not satisfied.

The present disclosure includes all kinds of change, replacement, deformation, modification, or correction that would be thought of by the skilled person in the art based on the present disclosure. The accompanying claims include all kinds of change, replacement, deformation, modification, or correction that would be thought of by the skilled person in the art based on the claims. In addition, the present disclosure includes an optional combination, which would be thought of by the skilled person in the art, of one or more characteristics of an embodiment or example in the present disclosure and one or more characteristics of another embodiment or example in the present disclosure.

Reference to a device, a system, or a device or system component that is adapted, disposed, enabled, configured, usable, operable, or can operate for achieving a particular function in the accompanying claims includes the device, the system, or the component irrespective of whether the device, the system, the component, or the particular function is activated, turned on, or unlocked as long as the device, the system, or the component is thus adapted, disposed, enabled, configured, usable, operable, or can operate.

In the present disclosure, agreement may be acquired from a user in advance when or right before any embodiment or example is achieved unless otherwise stated explicitly. The agreement may be acquired comprehensively or each time.

Each embodiment according to an example of the present disclosure will be described below with reference to the accompanying drawings. However, each embodiment or example described below is exemplary and not intended to exclude various kinds of modifications and applications of the technology that are not explicitly indicated below. In other words, the example of the present disclosure may be modified in various manners without departing from the scope thereof. In the following description of the drawings, parts identical or similar to each other are denoted by identical or similar reference signs, and the drawings are schematic and do not necessarily match actual dimensions and ratios. In addition, the drawings may include parts between which dimensional relations and ratios are different.

### First Embodiment

A first embodiment is an embodiment in which, in the trade system among users, trade system 1, a listing user as a first user is allowed to postpone repayment of a debt associated with the listing user based on a listed item listed by the listing user by permitting delay of the debt repayment based on the listed price or market price of the listed item.

FIG. 3 is a diagram for description of the configuration of the trade system according to the first embodiment. In this configuration, the trade system 1 is established by a plurality of information processing devices 200, for example, the terminal 120A of a listing user, the terminal 120B of a purchase user, and the server 110A used by a person who operates and manages an electronic trade platform.

The server 110A may cooperate as necessary with the server 110B managed by a creditor of a debt that the user has. The server 110B may be a server related to a payment service cooperating with the electronic trade platform. The present disclosure is not limited thereto, but each processing, each function, or each method of the present disclosure may be achieved by one server as which the server 110A and the server 110B are integrated. The server 110A may achieve at least one processing, function, or method achieved by the server 110B, and the server 110B may achieve at least one processing, function, or method achieved by the server 110A.

The payment service provided by the server 110B may be any payment service to which the present disclosure is applicable. For example, the payment service may be code payment using a two-dimensional code or the like or may be payment using electronic money or the like.

In the example illustrated in FIG. 3, a service in which electronic trade and debt delay permission are related with each other is performed in the order of A. listing of a listed item on the electronic trade platform, B. delay permission of debt repayment, C. delay request and delay processing of debt repayment, D. trade of the listed item, and E. delayed debt repayment. The following describes the process of the service.

(A. Listing of Listed Item on Electronic Trade Platform)

The listing user registers, on the electronic trade platform by using the terminal 120A, information and the price of a listed item that the listing user desires to sell. Accordingly, the item is listed on the electronic trade platform. On the electronic trade platform, item information is released and can be browsed by other users. The server 110A specifies the market price of the listed item based on trade information of the electronic trade platform. In this case, the server 110A may additionally specify a credence score of the listing user.

(B. Delay Permission of Debt Repayment)

Once the item is listed, the server 110A determines, based on the listed price of the listed item or the market price of the listed item, whether to permit delay of repayment of a debt associated with the listing user. In this case, the number of days, a due day, and the number of times (hereinafter also simply referred to as “the number of delayed days”) for which delay of the debt to be postponed is permitted, and a debt amount (hereinafter also simply referred to as “delay amount”) in which the delay is permitted may be determined.

(C. Delay Request and Delay Processing of Debt Repayment)

Then, the server 110A transmits a notification related to the delay permission of debt repayment to the listing user. Thereafter, when having received a delay request that delay of debt repayment is desired from the terminal 120A used by the listing user, the server 110A executes delay processing of the debt associated with the listing user.

The number of delayed days and/or the delay amount may be determined at a predetermined timing. For example, the server 110A may determine the number of delayed days and/or the delay amount when the item is listed or when an action from the terminal 120B used by a purchase candidate user of the listed item is received. The action from the purchase candidate user may be any action on the listed item. The action from the purchase candidate user may be not restrictively but exemplarily browse of a page of the listed item, bookmark registration of the listed item and/or likes on the listed item (hereinafter also simply referred to as “bookmark registration” or the like), and comment provision on the listed item.

The server 110A may determine the number of delayed days and/or the delay amount when a predetermined condition is satisfied. For example, the predetermined condition may include that the listed price or market price of the listed item is equal to or larger than a predetermined value, the number of listed items being listed is equal to or larger than a predetermined value, the number of trades is equal to or larger than a predetermined number of times, or the number of listed items for which a bookmark is registered is equal to or larger than a predetermined value.

(D. Trade of Listed Item)

The purchase user browses item information of a listed item listed on the electronic trade platform and determines a listed item to be purchased. A trade may be executed through trade processing by a well-known electronic trade platform. Accordingly, the trade is performed and delivery processing and payment processing of the listed item are executed.

(E. Delayed Debt Repayment)

The listing user having received postponement of the repayment day of the debt repays the debt by the postponed repayment day. The debt repayment method is not limited to a particular method but may be performed by a method determined at the delay request. For example, when the listed item is traded, part of payment thereof may be allotted to the debt repayment, or the repayment may be performed by the listing user using a well-known repayment method by a predetermined deadline irrespective of whether the listed item is traded.

Effects of First Embodiment

According to the first embodiment, a listing user can receive delay permission of debt repayment based on the listed price or market price of a listed item. Accordingly, for example, the listing user can more flexibly repay a debt since the debt repayment is extended through listing of the listed item. In addition, the server 110A postpones a repayment day in association with the listed item so that a bond for the debt can be directly or indirectly collected from sale proceeds of the listed item. Accordingly, the risk of bond collection can be reduced for the provider of a loan.

Configuration of First Embodiment

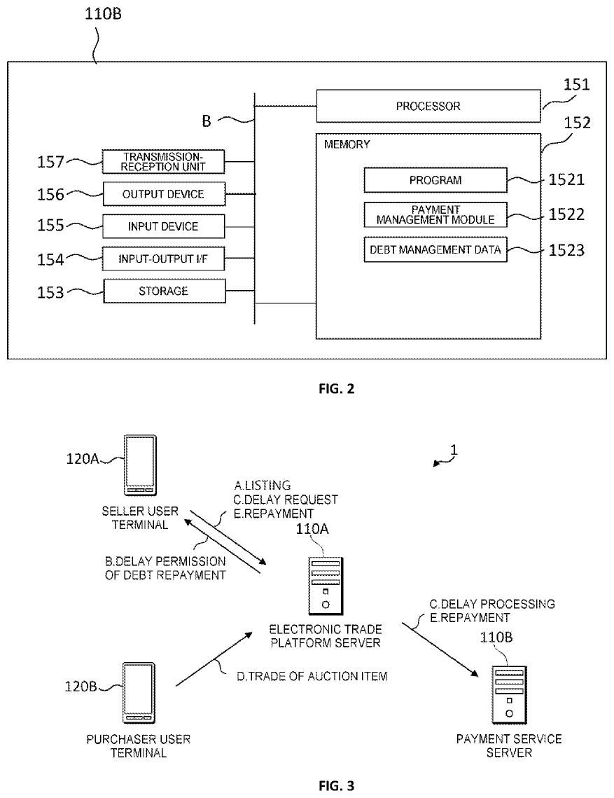

The configurations of the server 110A, the server 110B, and the terminal 120 will be described below with reference to FIGS. 1 to 2.

### (1) Configuration of Server 110A

FIG. 1 is an exemplary block diagram illustrating the configuration of the server 110A according to the first embodiment. The server 110A executes processing related to a debt delay service using a listed item on the electronic trade platform. The server 110A includes, for example, a listing management module 1122, a debt information management module 1123, and a repayment processing module 1124. Each processing may be achieved by machine learning or artificial intelligence (AI) as long as it is possible.

Each module disclosed in FIG. 1 is achieved through cooperation of the processor 111, the memory 112, the storage 113, the input-output I/F 114, the input device 115, the output device 116, and the transmission-reception unit 117, which are included in the server 110A. For example, the listing management module 1122, the debt information management module 1123, and the repayment processing module 1124 can be each achieved by the processor 111 reading and executing a program stored in the storage 113.

The listing management module 1122 sets a listed item ID based on a listing request for a listed item and stores item information and a listed price transmitted by a listing user in trade management data 1126. The item information is information for specifying the listed item, such as a listed item image of the listed item, which is captured by the listing user, and an item name input or selected by the listing user. The listing management module 1122 may specify the market price of the listed item based on the trade management data 1126 and store the market price in the trade management data 1126 in association with the listed item.

The listing management module 1122 may calculate a credence score of a user who uses the electronic trade platform based on the trade management data 1126 and store the credence score in user management data 1125. The credence score of the user is an index that indicates creditworthiness of the user and can vary with user information and user behavior. Such a credence score may be not restrictively but exemplarily calculated based on user behavior information such as the number of trades, the number of trade evaluations, the ratio of high evaluation in trade evaluations, and the swiftness of trade. Alternatively, the credence score may be calculated by a well-known technology and may include a well-known calculation element.

Then, the listing management module 1122 lists the listed item by using item information and the listed price stored in the trade management data 1126 and executes processing related to electronic trade. For example, the listing management module 1122 releases item information, executes a trade of the listed item, and executes processing of mediating a trade between the listing user and a purchase user until the trade is completed. When having acquired agreement between the listing user and the purchase user, the listing management module 1122 regards that the trade is completed, and executes payment processing.

In the payment processing, the listing management module 1122 checks the trade management data 1126. When delay of repayment of a debt is permitted based on the traded listed item, the listing management module 1122 can instruct the repayment processing module 1124 to execute repayment processing of the debt.

The debt information management module 1123 determines whether to permit delay of debt repayment based on the listed price or market price of the listed item. Alternatively, the debt information management module 1123 may determine whether to permit delay of debt repayment based on the listed price or market price of the listed item and the credence score of the listing user. Then, when the listing user desires delay of debt repayment, the debt information management module 1123 executes debt delay processing. For example, the debt information management module 1123 may permit delay of debt repayment only when the listed price or market price is in a predetermined price range or when the credence score is equal to or larger than a predetermined threshold value. The debt information management module 1123 may determine a larger number of delayed days and a larger delay amount as the listed price or market price is higher. The debt information management module 1123 may determine a larger number of delayed days and a larger delay amount as the credence score is higher.

Before the above-described delay permission of debt repayment, the debt information management module 1123 may execute processing of acquiring debt information related to a debt of a user who uses the electronic trade platform. For example, the debt information management module 1123 acquires, as the debt information, payment information received from the terminal 120 of the user, a terminal of a shop, or the server 110B and related to deferred payment or the like that payment processing is performed after elapse of a predetermined duration. The debt information may include, for example, information related to a payment amount and a payment day for each payment information.

When a user who uses the electronic trade platform has a debt, the debt information management module 1123 performs control to transmit the debt information to the terminal 120 through the transmission-reception unit 117. The debt information management module 1123 also performs control to transmit a notification that recommends listing of a listed item on the electronic trade platform together with the debt information to the terminal 120 through the transmission-reception unit 117.

The debt information management module 1123 receives, from the terminal 120A used by the listing user having a debt through the transmission-reception unit 117, a delay request that the user desires delay of debt repayment based on a listed item to be listed or being listed. For example, when having received the delay request, the debt information management module 1123 may store the delay request in information related to the listed item in the trade management data 1126.

The repayment processing module 1124 executes processing of repaying the debt of the listing user. For example, when a trade of the listed item associated with the delay request is completed, the repayment processing module 1124 executes repayment processing of allotting the sale proceeds of the listed item to repayment of the debt. When the repayment processing is completed, the repayment processing module 1124 may update the debt information of the user and transmit a debt balance to the user.

When the user obtains sale proceeds from a plurality of listed items, the repayment processing module 1124 may sum the sale proceeds of the plurality of listed items and execute debt repayment processing. In this case, the repayment processing module 1124 may specify a combination of sale proceeds, the sum of which is larger than a debt amount and closest to the debt amount and may allot the sum of the sale proceeds to debt repayment.

The repayment processing module 1124 may associate, with the user as a money equivalent usable on the electronic trade platform, an amount by which the sum of the sale proceeds exceeds the debt amount. When the sum of the sale proceeds is smaller than the debt amount, the repayment processing module 1124 may compensate the difference therebetween with a money equivalent that the user obtains by top-up or by getting points. The money equivalent includes an electronic value that the user obtains by top-up or by getting points.

A debt on which the repayment processing module 1124 performs repayment processing may include a debt generated by a payment service in cooperation with the electronic trade platform. The debt generated by a payment service in cooperation with the electronic trade platform includes a debt generated through a trade in the electronic trade platform as well as a debt generated out of the electronic trade platform. Thus, for example, a debt generated as payment processing using an information code such as a bar code or a QR code (registered trademark) is performed in a real shop can be repaid with the sale proceeds of a listed item listed on the electronic trade platform.

In addition, the debt on which the repayment processing module 1124 performs repayment processing may include a debt generated by a service provided by the above-described payment service in cooperation with the electronic trade platform. More specifically, the debt on which the repayment processing module 1124 performs repayment processing may include a debt generated by deferred payment, and a debt due to a loan. The deferred payment may include payment methods such as deferred payment per month, installment payment, and revolving payment.

The debt generated out of the electronic trade platform may be managed by the server 110B that provides the payment service or may be managed by the server 110 as an integration of the server 110A and the server 110B. The server 110A may acquire information related to the debt from the server 110B. When the debt is managed by the server 110B, repayment processing by the repayment processing module 1124 of the server 110A includes, for example, processing of transferring money corresponding to repayment to the server 110B and causing the server 110B to execute debt repayment processing.

Through the above-described processing, the listing user can receive postponement of the repayment day of a debt in accordance with listing on the electronic trade platform, thereby achieving more flexible debt repayment. Accordingly, listing on the electronic trade platform, which is intended to postpone a debt repayment day, can be promoted.

The timing when the debt information management module 1123 determines delay permission of debt repayment is not particularly limited, but delay of debt repayment may be permitted at the timing of listing as well as the timing when the status of a listed item being listed has changed. Examples of such timings include the timing when the item is listed, the timing when an action from a purchase candidate user on the listed item is received, the timing when the market price of the listed item has changed, and the timing when scarcity of the listed item has changed.

The timing when the debt information management module 1123 determines the number of delayed days and/or the delay amount is not particularly limited, but delay of debt repayment may be permitted at the timing of listing as well as the timing when the status of a listed item being listed has changed. The debt information management module 1123 may update information of the trade management data 1126 when having determined or updated the number of delayed days and/or the delay amount.

For example, when a listed item is listed, the debt information management module 1123 may determine the number of delayed days and/or the delay amount based on easiness to sell the listed item on the electronic trade platform, which is specified from the listed price and market price of the listed item, and the credence score of the listing user.

More specifically, when the listed price determined by the listing user is lower than the market price, the probability that the listed item is sold is high, and thus the debt information management module 1123 sets a larger number of delayed days and a larger delay amount than when the listed price is higher than the market price. When the listed price of the listed item is higher than the market price but the scarcity of the listed item is high, the probability that the listed item is sold is high, and thus the debt information management module 1123 sets a larger number of delayed days and a larger delay amount.

When the credence score of the listing user is high, the probability that the listed item is traded is high or the reliability that the listing user repays a debt is high, and thus the debt information management module 1123 may set a larger number of delayed days and/or a larger delay amount as the credence score of the listing user is higher. The number of delayed days and/or the delay amount may be each independently determined or may be determined based on a balance therebetween. When the determination is made based on the balance therebetween, for example, a larger delay amount may be set as the number of delayed days is smaller, or a larger number of delayed days may be set as the delay amount is smaller. This setting may be automatically determined by the server 110A or the server 110B or may be set by the first user.

Accordingly, the number of delayed days and/or the delay amount can be more flexibly determined based on the reliability that the listing user repays a debt.

When the listed item market price of a category to which the listed item belongs or the scarcity of the listed item has changed after listing, the debt information management module 1123 may redetermine the number of delayed days and/or the delay amount. The listing management module 1122 of the server 110A may determine the market price of the listed item and the credence score based on current or past trade data in the trade management data 1126 and store the market price and/or the credence score in the user management data 1125 and/or the trade management data 1126.

When an action from another purchase candidate user (second user) is performed on the listed item, the debt information management module 1123 may determine the number of delayed days and/or the delay amount based on the action. Examples of the action include browse of a listed item page, bookmark registration of the listed item, and comment provision on the listed item. The probability that the listed item is sold is higher as the number of times of browse of the listed item page, the number of times of bookmark registration, or the number of comments is larger, and thus the debt information management module 1123 may set a larger number of delayed days and a larger delay amount. The number of delayed days and/or the delay amount may be determined based on a ratio of the number of times of browse of the listed item page, the number of times of bookmark registration of the listed item, or the number of comments provided to the listed item.

More specifically, when the ratio of the number of times of bookmark registration of the listed item or the number of comments provided to the listed item relative to the number of times of browse of the listed item page is large, the number of delayed days and/or the delay amount may set to be larger than when the ratio is small. This is because it can be estimated that a large number of users highly intend to purchase the listed item when the ratio of the number of times of bookmark registration of the listed item or the number of comments provided to the listed item relative to the number of times of browse of the listed item page is large.

In addition, the debt information management module 1123 may determine the number of delayed days and/or the delay amount based on the contents of comments. For example, the probability that the listed item is sold is high when comments on the listed item include keywords, such as “swiftly . . . ” and “thank you”, which frequently appear right before the listed item is sold, and thus the debt information management module 1123 may set a larger number of delayed days and a larger delay amount.

Accordingly, the number of delayed days and/or the delay amount can be more flexibly determined based on easiness to sell the listed item on the electronic trade platform.

When listing of a listed item is canceled, the debt information management module 1123 may cancel delay permission of debt repayment, which is provided to the listed item. When an identical item is listed in a predetermined duration after listing of a listed item is canceled, the debt information management module 1123 may determine that delay permission of debt repayment is not performed based on the listed item. In this case, the debt information management module 1123 may determine whether the canceled listed item and the newly listed item are identical based on the similarity between the canceled listed item and the newly listed item. In addition, when listing of a listed item related to a delay request on the repayment day of a debt is canceled after the delay request, the debt information management module 1123 may execute processing of reducing the credence score of the listing user.

Accordingly, the risk that listing intended for delay permission of debt repayment is performed for cancellation can be reduced. In addition, when an identical item is listed in a predetermined duration after listing of a listed item is canceled, the debt information management module 1123 may permit a predetermined number of times of listing to prevent excessive restriction of delay permission of debt repayment on false listing due to a false operation or the like. When cancellation is performed after a repayment scheduled day (original repayment day) before delay permission of debt repayment for a listed item is performed, a nearest repayment scheduled day on or later than the original repayment scheduled day and on or later than a day on which the cancellation is performed may be set as a new repayment scheduled day.

When a listed item is traded, the debt information management module 1123 may cancel delay permission of debt repayment for the listed item. More specifically, the debt information management module 1123 may cancel the delay permission of debt repayment, and the repayment processing module 1124 may execute repayment processing of allotting at least part of the sale proceeds of the listed item to repayment of a debt associated with the listing user. In this case, the repayment processing module 1124 may allot the sale proceeds of the listed item to repayment of a debt of a nearest repayment day on or later than a day on which the listed item is traded. After having executed the repayment processing, the repayment processing module 1124 may execute processing of increasing the credence score of the listing user.

Accordingly, debt repayment can be smoothly executed when a listed item is traded. In addition, a debt of a nearest repayment day on or later than a day on which the listed item is traded is preferentially repaid, thereby reducing the risk that the repayment day is passed.

The debt information management module 1123 may calculate, for example, a listed price sum or a market price sum of a plurality of listed items listed by the listing user and may determine the number of delayed days and/or the delay amount based on the sums and the credence score. Calculation of the listed price sum or the market price sum may be limited to listed items listed in a predetermined duration.

Accordingly, the number of delayed days and a postponed debt amount can be determined when the prices of individual listed items listed by the listing user are low and the number of delayed days and/or the postponed debt amount cannot be sufficiently determined with one listed item.

When having performed processing of postponing the repayment day of a debt, the debt information management module 1123 may perform, for some or all listed items listed by the listing user, listing cancellation and/or processing of restricting the amount of increase and decrease of the listed prices of the listed items, as collateral of the postponement processing. The amount of increase and decrease of the listed prices may be permitted in a predetermined money amount or a predetermined money amount ratio. In addition, when all or part of a debt related to the postponement processing is repaid by the listing user, the debt information management module 1123 may remove listing cancellation and/or restriction on the amount of increase and decrease of the listed prices of the listed items. When applying or removing such a restriction, the debt information management module 1123 may store information related to the restriction in the trade management data 1126.

Accordingly, the listing user can be prevented from improperly receiving delay permission of debt repayment by canceling a listed item or increasing and decreasing the listed price thereof, thereby reducing the risk that bond collection becomes impossible.

When postponing the repayment day of a debt, the debt information management module 1123 may perform processing of requesting storage of some or all listed items listed by the listing user at a facility managed by the electronic trade platform and sensing storage of the listed items. In addition, when all or part of the debt is repaid by the listing user, the debt information management module 1123 may perform processing of receiving a return request for returning the listed items stored at the facility back to the listing user. When storing or returning the listed items in this manner, the debt information management module 1123 may store information related to the storage or return in the trade management data 1126.

When the repayment day of a debt is postponed as described above, a listed item under management of the listing user is placed under management of the electronic trade platform, thereby reducing the risk that the listed item is not traded because, for example, the listing user does not ship the listed item to a purchase user. Thus, the risk that bond collection becomes impossible can be reduced.

When a listed item is traded, the debt information management module 1123 may execute processing of allotting part or all of the sale proceeds of the listed item to repayment of a postponed debt.

Accordingly, bond collection can be performed when the listing user acquires sale proceeds, and thus the risk that bond collection becomes impossible can be reduced. In addition, the listing user can easily proceed debt repayment procedure and thus reduce work of repayment.

The storage 113 stores a program executed by the server 110A according to the first embodiment, the user management data 1125 with which a user as a member of the electronic trade platform is managed, and the trade management data 1126 with which a trade executed on the electronic trade platform is managed. These data will be described later.

One or a plurality of processors 111 read and execute each module from the memory 112 as necessary. For example, the one or plurality of processors 111 may achieve a listing management unit, a debt information management unit, and a repayment processing unit by executing each of the listing management module 1122, the debt information management module 1123, and the repayment processing module 1124.

### (2) Configuration of Server 110B

FIG. 2 is an exemplary block diagram illustrating the configuration of the server 110B according to the first embodiment. The server 110B is a server related to a payment service in cooperation with the electronic trade platform and executes processing managed by a creditor of a debt of a user. The server 110B includes, for example, a payment management module 1522. Each processing may be achieved by machine learning, artificial intelligence (AI), or the like as long as it is possible.

Each module disclosed in FIG. 2 is achieved through cooperation of a processor 151, a memory 152, a storage 153, an input-output I/F 154, an input device 155, an output device 156, and a transmission-reception unit 157, which are included in the server 110B. For example, the payment management module 1522 can be each achieved by the processor 151 reading and executing a program stored in the storage 153.

In FIG. 2, the processor 151, the memory 152, the storage 153, the input-output I/F 154, the input device 155, the output device 156, and the transmission-reception unit 157 correspond to the processor 111, the memory 112, the storage 113, the input-output I/F 114, the input device 115, the output device 116, and the transmission-reception unit 117, respectively.

The payment management module 1522 executes various kinds of processing for executing debt payment. For example, the payment management module 1522 receives payment information from the terminal 120 of a user and stores a debt of the user in debt management data 1523. The payment information may include the generation day of the debt, the amount of the debt, and the repayment day of the debt. The payment management module 1522 may receive the payment information from another terminal of the user or a terminal of a payee shop.

The payment management module 1522 receives money corresponding to repayment from a server 100A, and executes debt repayment processing at the server 110B when having received an instruction to execute debt repayment processing.

One or a plurality of processors 151 read and execute each module from the memory 152 as necessary. For example, the one or plurality of processors 151 may achieve a payment check unit and a display control unit by executing the payment management module 1522.

(3) Configuration of Terminal 120

FIG. 1 is an exemplary block diagram illustrating the configuration of the terminal 120 according to the first embodiment. The terminal 120 is a terminal used by a listing user or a purchase user on the electronic trade platform. The terminal 120 includes, for example, a display control module 1222, a trade processing module 1223, a delay request module 1224, and a payment processing module 1225. Each processing may be achieved by machine learning or artificial intelligence (AI) as long as it is possible.

Each module disclosed in FIG. 1 is achieved through cooperation of the processor 121, the memory 122, the storage 123, the input-output I/F 124, the input device 125, the output device 126, and the transmission-reception unit 127, which are included in the terminal 120. For example, the display control module 1222, the trade processing module 1223, the delay request module 1224, and the payment processing module 1225 can be each achieved by the processor 121 reading and executing a program stored in the storage 123.

For example, the display control module 1222 controls, based on screen information received from the server 110A, a display device (for example, a touch panel) to display listing auxiliary screen, an electronic trade screen, a screen for requesting debt repayment delay, a screen for repaying a debt, a screen for checking a repayment status, and the like.

The display control module 1222 may control display of a screen for displaying information related to a possessed item list received from the server 110A and a screen for displaying the number of delayed days and/or the delay amount permitted when an item included in the possessed item list is listed.

The trade processing module 1223 executes processing related to an electronic trade. For example, the trade processing module 1223 executes, as a listing user side, processing of registering item information and processing of performing negotiation on a listed item with a purchase user. The trade processing module 1223 executes, as a purchase user side, processing of instructing various actions on a listed item, such as browse of the listed item and selection of the listed item, and payment.

The delay request module 1224 executes processing of requesting the server 110A for debt repayment delay based on a listed item listed on the listing user side. For example, in response to an operation by the listing user, the delay request module 1224 may transmit, through the transmission-reception unit 127, a request for debt repayment delay based on the listed item at or in listing. In response to an operation by the listing user, the delay request module 1224 may acquire debt information related to the listing user from the server 110A and control the display control module 1222 to perform screen display of the debt information.

The payment processing module 1225 executes payment with which a debt is generated. For example, the terminal 120 is controlled to read a two-dimensional code or the like of a shop and transmit, to the server 110B through the transmission-reception unit 127, payment information including a payee ID included in the two-dimensional code, a debtor ID, and a money amount set by inputting or the like.

The storage 123 stores a program executed by the terminal 120 according to the first embodiment and stores, for example, programs for executing processing that is related to an electronic trade and used by a listing user and a purchase user, and processing that assists debt repayment and is used by the listing user. The program for executing processing that is related to an electronic trade and the program for executing processing that assists debt repayment may be programs different from each other.

One or a plurality of processors 121 read and execute each module from the memory 122 as necessary. For example, the one or plurality of processors 121 may achieve a display control unit, a trade processing unit, a repayment request unit, and a payment processing unit by executing the display control module 1222, the trade processing module 1223, the delay request module 1224, and the payment processing module 1225, respectively.

### Exemplary Data

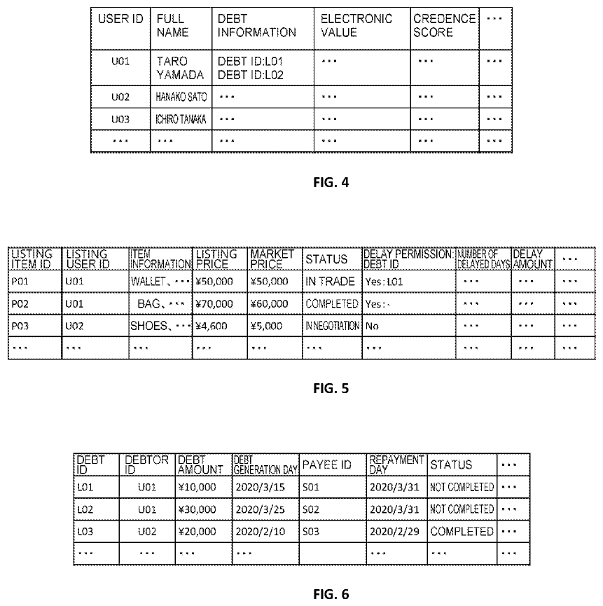

The following describes data of the server 110A and the server 110B with reference to FIGS. 4 to 6.

FIG. 4 is a diagram illustrating exemplary user management data 1125 stored in the storage 113 or the memory 112 of the server 110A according to the first embodiment. The user management data 1125 manages information related to each user produced by a person who operates and manages the electronic trade platform. The “user ID” includes user identification information for the server 110A to uniquely identify a user. The user management data 1125 may include the “full name” of the user as well as user information such as an address and a phone number thereof.

The user management data 1125 also includes, for example, debt information related to a debt of a user, account information such as electronic values and points that the user has, and the credence score of the user. The “debt information” may include, as information related to a debt that the user has, a debt ID for uniquely identifying the debt, and the repayment day and repayment amount of the debt, which are specified by the debt ID. For example, the “debt information” is updated by the debt information management module 1123 when a debt is generated and when repayment of the debt is performed by the repayment processing module 1124. The “credence score” is an index that indicates the creditworthiness of the user.

FIG. 5 is a diagram illustrating exemplary trade management data 1126 stored in the storage 113 or the memory 112 of the server 110A according to the embodiment. The “listed item ID” includes identification information for the server 110A to uniquely identify a listed item. The “listing user ID” includes the user ID of a listing user. The “item information” includes information related to a repayment request for a listed item, the item name and description of the listed item, a registration day of the listed item, and other information related to the item. The “listed price” includes the listed price of an item, which is determined by a listing user.

The “status” in the trade management data 1126 includes the state of a trade in an electronic trade. The status includes “in trade” indicating that a listed item is currently in trade, “in negotiation” indicating that the trade is in negotiation with a purchase user, and “completed” indicating that the trade is completed. The “trade completion day” includes a proceeds generation day as a day on which the trade is completed. The “purchase user ID” includes the user ID of a user having bought an item.

The “delay permission” in the trade management data 1126 includes information related to the existence of delay permission and indicating whether debt delay is permitted based on the listed item of a listed item ID. The existence of delay permission may include an ID specifying a debt permitted to be delayed. “The number of delayed days” and the “delay amount” include the number of days by which and a debt amount in which delay is permitted, respectively. The “delay permission”, “the number of delayed days”, and the “delay amount” are updated by, for example, the debt information management module 1123.

FIG. 6 is a diagram illustrating exemplary debt management data 1523 stored in the storage 153 or the memory 152 of the server 110B according to the embodiment. The “debt ID” includes identification information for the server 110A to uniquely identify a debt. The “debtor ID” includes identification information issued by a payment operator to specify a user. The “payee ID” is identification information that specifies a shop read from, for example, a two-dimensional code, and includes information issued by a payment operator. The “debt amount”, the “debt generation day”, and the “repayment day” include the amount of a debt specified by a debt ID, the generation day of the debt, and the repayment day of the debt, respectively. The “status” includes the state of debt repayment. The status includes “completed” indicating that the repayment is completed, and “not completed” indicating that the repayment is yet to be completed. Although not illustrated, identification information with which a payment operator can be specified may be included.

Operation Processing of First Embodiment

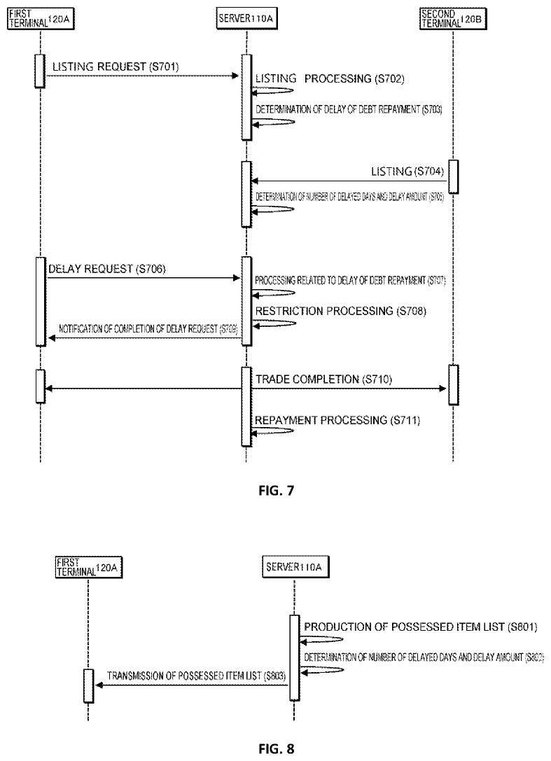

The following describes processing by the trade system 1 according to the first embodiment with reference to FIG. 7.

(Step S701)

In accordance with an operation by the listing user, the trade processing module 1223 of the terminal 120A transmits item information and the price of a listed item as well as a listing request for the listed item to the server 110A through the transmission-reception unit 127. The item information includes, for example, image information of the listed item and the name of the listed item.

(Step S702)

The listing management module 1122 of the server 110A executes processing of listing the listed item for which the listing request is received. For example, the transmission-reception unit 127 of the server 110A receives information related to the listed item together with the listing request, and the listing management module 1122 sets a listing ID in accordance with the listing request and stores the information related to the listed item in the trade management data 1126. The listing management module 1122 of the server 110A releases item information and a listed price on the electronic trade platform so that the item information and the listed price can be browsed by an optional user.

(Step S703)

The debt information management module 1123 of the server 110A determines whether to permit delay of a debt based on the listed item and stores a result of the determination in the trade management data 1126. In this case, the debt information management module 1123 may determine the number of delayed days and/or the delay amount based on the listed price or market price of the listed item and the credence score of the listing user and may store a result of the determination in the trade management data 1126. The determination of debt postponement permission may result in determination that debt postponement is not permitted. In this case, the debt information management module 1123 may store, in the trade management data 1126, a result in determination that debt postponement is not permitted.

The debt information management module 1123 of the server 110A may transmit, to the terminal 120A through the transmission-reception unit 117, a result of determination of whether to permit delay of debt repayment. In this case, when having determined the number of delayed days and/or the delay amount, the debt information management module 1123 may also transmit the number of delayed days and/or the delay amount to the terminal 120A through the transmission-reception unit 117.

(Step S704)

The listing management module 1122 of the server 110A receives, through the transmission-reception unit 127, an action from the terminal 120B used by a purchase candidate user on the listed item. Examples of the action include browse of a listed item page, bookmark registration of the listed item, and comment provision to the listed item. The listing management module 1122 stores information related to the action, such as the number of times of browse of the listed item page, the number of times of bookmark registration of the listed item, the number of comments, and/or comment contents, in the trade management data 1126.

(Step S705)

The debt information management module 1123 of the server 110A determines the number of delayed days and/or the delay amount based on, for example, the action stored in the trade management data 1126 and stores the number of delayed days and/or the delay amount in the trade management data 1126. In this case, the number of delayed days and/or the delay amount stored in the trade management data 1126 in the past may be updated.

(Step S706)

At step S706, the delay request module 1224 of the terminal 120A transmits a request for debt repayment delay together with the listed item ID to the server 110A in accordance with an operation by the listing user. In this case, consensus formation on a repayment method and a repayment condition of a debt to be delayed may be performed between the delay request module 1224 of the terminal 120A and the debt information management module 1123 of the server 110A. The request for debt repayment delay may be transmitted simultaneously with the listing request (step S701).

(Step S707)

The debt information management module 1123 of the server 110A executes processing related to delay of debt repayment. For example, the debt information management module 1123 may store the number of delayed days and/or the delay amount related to the delay request in the trade management data 1126. When the server 110B independently exists, the debt information management module 1123 of the server 110A may notify the server 110B of execution of the delay request and the number of delayed days and/or the delay amount related to the delay request.

(Step S708)

For example, the debt information management module 1123 of the server 110A may perform, for a listed item corresponding to a listed item ID related to the delay request, listing cancellation and/or processing of restricting the amount of increase and decrease of the price of a listed item.

(Step S709)

The debt information management module 1123 of the server 110A instructs the transmission-reception unit 117 to transmit, to the listing user, a notification that delay of debt repayment is executed based on the delay request.

(Step S710)

The listing management module 1122 of the server 110A mediates the listing user and a purchase user and executes processing of trading the listed item. The listing management module 1122 can trade the listed item by executing processing provided by a well-known electronic trade platform.

(Step S711)

The listing management module 1122 of the server 110A checks the trade management data 1126, and when a traded item is a target of the delay request, the listing management module 1122 instructs the repayment processing module 1124 to execute repayment processing of a debt related to the delay request. Then, the repayment processing module 1124 refers to the trade management data 1126 and executes repayment processing of allotting the proceeds of an item, trading of which is completed to repayment of the debt.

For a debt generated at the server 110B out of the electronic trade platform, the repayment processing module 1124 may perform control to transmit a request for execution of debt repayment processing to the server 110B through the transmission-reception unit 117. Completion of a trade may be selling of a listed item, payment for the item by a purchase user, notification of the server 110A that the item is received by the purchase user, or completion of evaluation by the purchase user and the listing user.

The present disclosure is not limited to the above-described embodiment but may be performed in other various forms without departing from the scope of the present disclosure. For example, the above-described processing steps may be executed in an optionally changed order or in parallel without inconsistency in processing contents.

### Example

An example of the first embodiment is an example in which an item list (hereinafter also simply referred to as a “possessed item list”) including an unlisted item possessed by a listing user is acquired and the number of delayed days and/or the delay amount permitted when an item included in the possessed item list is listed is transmitted to the terminal 120A of the listing user together with the possessed item list.

### Effects of Example

According to the example, before listing, a listing user can easily know each possessed item of the listing user and the number of delayed days and/or the delay amount when the possessed item is listed. Thus, it is possible to further promote listing for postponement of the repayment day of a debt on the electronic trade platform. In addition, it is possible to motivate registration of an item into the possessed item list.

### Configuration of Example

In the following description, a component same as that in the first embodiment is denoted by the same reference sign, and description thereof is omitted. Description of operations and effects same as those of the first embodiment is also omitted. The description is mainly made on difference from the first embodiment.

In the present example, the listing management module 1122 can produce a list of items possessed by the listing user by extracting, from the trade management data 1126, any item bought by the listing user by using the electronic trade platform but yet to be sold. The listing management module 1122 may receive unlisted information related to any unlisted item from the terminal 120 of the listing user and produce a list of items possessed by the listing user based on the unlisted information. In this case, the listing management module 1122 may store information related to the possessed item list in the user management data 1125.

The debt information management module 1123 transmits, to the terminal 120A of the listing user together with the possessed item list of the user, the number of delayed days and/or the delay amount permitted when each item included in the possessed item list is listed.

The debt information management module 1123 may permit delay of debt repayment when an unlisted item is added to the possessed item list. In this case, the number of delayed days and/or the delay amount may be determined based on information related to each item included in the possessed item list, the number of items, and the like.

Accordingly, it is possible to promote, as a previous step to listed item registration into the possessed item list, and as a result, it is possible to promote item listing on the electronic trade platform.

Operation Processing of Example

The following describes processing by the trade system 1 according to the example with reference to FIG. 8.

(Step S801)

In the example, a process after step S801 at which possessed item list production processing is performed may be same as that of the first embodiment. Step S801 is the previous step of the listing request (S701). The listing management module 1122 of the server 110A refers to the trade management data 1126 and produces the possessed item list of the user. The listing management module 1122 may receive unlisted information related to any unlisted item from the terminal 120 of the listing user and produce a list of items possessed by the listing user based on the unlisted information.

(Step S802)

The debt information management module 1123 of the server 110A produces data related to the number of delayed days and/or the delay amount permitted when each item included in the possessed item list is listed. In this case, the debt information management module 1123 may produce data related to the number of delayed days and/or the delay amount based on the market price of the item and the credence score of the user.

(Step S803)

The debt information management module 1123 of the server 110A instructs the transmission-reception unit 127 to transmit the data related to the number of delayed days and/or the delay amount to the terminal 120A together with the possessed item list. Then, the display control module 1222 of the terminal 120A performs control to display the possessed item list and the data related to the number of delayed days and/or the delay amount on a screen of the terminal 120A.

The number of delayed days and/or the delay amount of each item possessed by the listing user when the item is listed is notified through the above-described processing, thereby promoting listing. In addition, as a larger amount of sale proceeds is obtained through listing by the listing user, the opportunity of bond collection increases, and thus the risk that bond collection becomes impossible can be reduced.

In the above description, the description was made in the form of delay of repayment of a debt associated with a listing user is permitted based on the listed price or market price of a listed item and the credence score of the listing user. A configuration related to the credence score is optional. More specifically, delay of repayment of a debt associated with a listing user may be permitted based on the listed price or market price of a listed item without using the credence score.

### Second Embodiment

A second embodiment is an embodiment in which, in the trade system among users, trade system 1, a credit is determined based on the listed price or market price of a listed item listed by a listing user as a first user and the credence score of the listing user and is added to a credit total associated with the listing user, thereby enabling, for the listing user, a loan based on the credit total of the listed item.

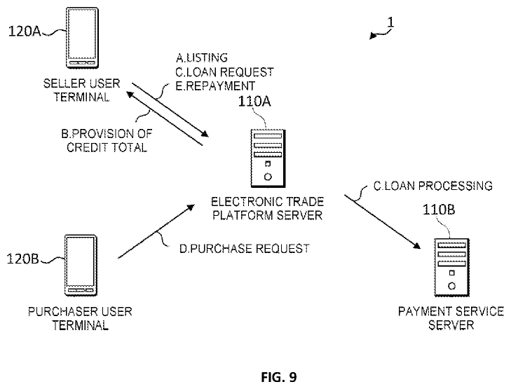

FIG. 9 is a diagram for description of the configuration of the trade system according to the second embodiment. In this configuration, the trade system 1 is established by a plurality of information processing devices 200, for example, the terminal 120A of the listing user, the terminal 120B of a purchase user, and the server 110A used by a person who operates and manages the electronic trade platform. The server 110A may cooperate with the server 110B that provides a payment service as necessary to achieve a loan. The server 110B may have a configuration same as that in the first embodiment.

In the example illustrated in FIG. 9, a service in which electronic trade and a loan are related with each other is performed in the order of A. listing of a listed item on the electronic trade platform, B. credit addition based on the listed item, C. loan execution, D. purchase of the listed item, and E. collection of a bond for executed loan. The following describes the process of the service.

(A. Listing of Listed Item on Electronic Trade Platform)

The listing user registers, on the electronic trade platform by using the terminal 120A, information and the price of a listed item that the listing user desires to sell. Accordingly, the item is listed on the electronic trade platform. On the electronic trade platform, item information is released and can be browsed by an optional user.

(B. Credit Provision Based on Listed Item)

When the item is listed, the server 110A determines a credit to be provided for the listed item based on the listed price or market price of the listed item and the credence score. The credit is provided for each listed item, and the listing user can receive a loan within the sum (hereinafter also referred to as a “credit total”) of the credit provided for each listed item listed by the listing user.

The credit determination may be performed at a predetermined timing. For example, the server 110A may perform the credit determination when a listed item is listed or when an action is received from the terminal 120B used by a purchase candidate user of the listed item. The action from the purchase candidate user may be any action on the listed item. The action may be not restrictively but exemplarily bookmark registration of the listed item and comment provision to the listed item. The server 110A may perform the credit determination when a predetermined condition is satisfied. For example, the predetermined condition may include that the money amount of the listed item is equal to or larger than a predetermined value, the number of listed items being listed is equal to or larger than a predetermined value, or the number of listed items for which a bookmark is registered is equal to or larger than a predetermined value.

(C. Loan Execution)

The listing user may perform a loan request to the server 110A by using the terminal 120A. The server 110A executes loan processing in accordance with the loan request. A loan method is not particularly limited, but for example, the server 110A may provide a loan by issuing a money equivalent usable on the electronic trade platform, or a predetermined fund may be loaned through an external system operated by another business operator such as a financial institution.

(D. Purchase of Listed Item)

A purchase user browses item information of a listed item listed on the electronic trade platform and determines a listed item to be purchased. Trade may be executed through trade processing by a well-known electronic trade platform. Accordingly, the trade is performed, and delivery processing and payment processing of the listed item are executed.

(E. Collection of Bond for Executed Loan)

The listing user having received a loan repays a debt by a predetermined deadline. The debt repayment is not limited to a particular method but may be performed by a method determined at the loan request. For example, when the listed item is traded, part of payment thereof may be allotted to the debt repayment, or the repayment may be performed by the predetermined deadline by the listing user having received the loan irrespective of whether the listed item is traded.

Effects of Second Embodiment

According to the second embodiment, a listing user can obtain a credit based on the listed price or market price of a listed item and the credence score of the listing user. Accordingly, for example, the listing user can receive a loan through listing of the listed item. In addition, a bond for the loan can be directly or indirectly collected from the sale proceeds of the listed item by providing a credit for the listed item. Accordingly, the risk of bond collection can be reduced for the provider of the loan

Configuration of Second Embodiment

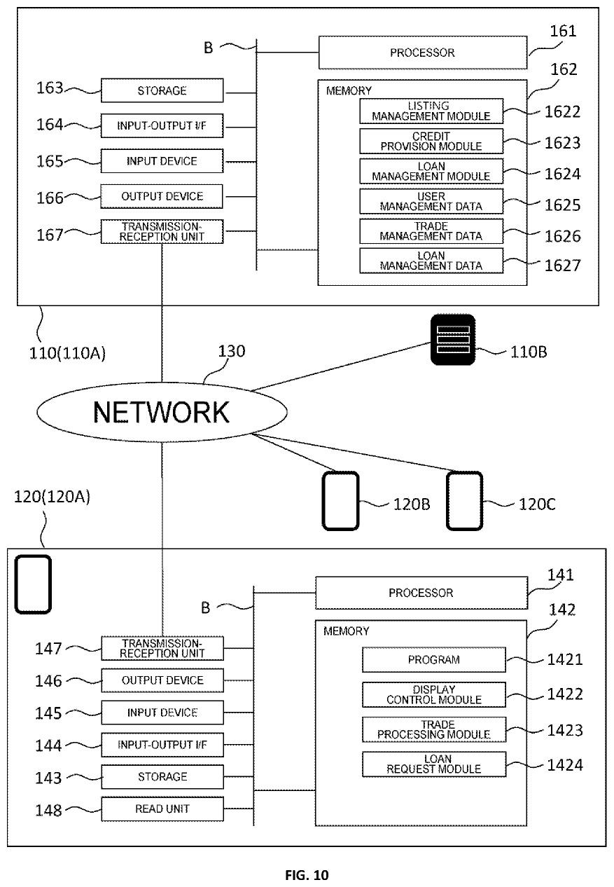

The configurations of the server 110A and the terminal 120 will be described with reference to FIG. 10.

(1) Configuration of Server 110A

FIG. 10 is an exemplary block diagram illustrating the configuration of the server 110A according to the second embodiment. The server 110A executes processing related to a loan service on the electronic trade platform. The server 110A includes, for example, a listing management module 1622, a credit provision module 1623, and a loan management module 1624. Each processing may be achieved by machine learning or artificial intelligence (AI) as long as it is possible.

Each module disclosed in FIG. 10 is achieved through cooperation of a processor 161, a memory 162, a storage 163, an input-output I/F 164, an input device 165, an output device 166, and a transmission-reception unit 167, which are included in the server 110A. For example, the listing management module 1622, the credit provision module 1623, and the loan management module 1624 can be each achieved by the processor 161 reading and executing a program stored in the storage 163.

In FIG. 10, the processor 161, the memory 162, the storage 163, the input-output I/F 164, the input device 165, the output device 166, and the transmission-reception unit 167 correspond to the processor 111, the memory 112, the storage 113, the input-output I/F 114, the input device 115, the output device 116, and the transmission-reception unit 117, respectively.

The listing management module 1622 sets a listed item ID based on a listing request for a listed item and stores item information and a listed price transmitted by the listing user in trade management data 1626. The item information is information for specifying the listed item, such as a listed item image of the listed item, which is captured by the listing user, and an item name input or selected by the listing user. In this case, the listing management module 1622 may specify the market price of the listed item based on the trade management data 1626 and store the market price in the trade management data 1626 in association with the listed item.

The listing management module 1622 may calculate a credence score of a user who uses the electronic trade platform based on the trade management data 1626 and store the credence score in user management data 1625. The credence score of the user is an index that indicates creditworthiness of the user and can vary with user information and user behavior. Such a credence score may be not restrictively but exemplarily calculated based on user behavior information such as the number of trades, the number of trade evaluations, the ratio of high evaluation in trade evaluations, and the swiftness of trade. Alternatively, the credence score may be calculated by a well-known technology and may include a well-known calculation element.

Then, the listing management module 1622 lists the listed item by using item information and the listed price stored in the trade management data 1626 and executes processing related to electronic trade. For example, the listing management module 1622 releases item information, executes trade of the listed item, and executes processing of mediating the listing user and a purchase user until the trade is completed. When having acquired agreement between the listing user and the purchase user, the listing management module 1622 regards that the trade is completed, and executes payment processing.

The credit provision module 1623 determines a credit provided for the listed item based on the listed price or market price of the listed item and the credence score, and adds the credit to a credit total associated with the listing user. More specifically, the credit provision module 1623 stores the determined credit in the trade management data 1626 and updates the credit total in user management data 1625. The credit may be determined by, for example, multiplying the price of the listed item by a credit rate. The credit rate is the ratio of a money amount that can be loaned within the price of the listed item. For example, when the credit rate for a listed item of ten thousands yen is 10%, the credit of one thousand yen is provided.

The timing of the credit determination by the credit provision module 1623 is not particularly limited, but the credit provision module 1623 may determine a credit when the status of the listed item is changed. Examples of such timings include when the item is listed, when an action is received from a purchase candidate user on the listed item, when the market price of the listed item has changed, when the scarcity of the listed item has changed. At such a timing, the credit provision module 1623 may adjust the credit rate in accordance with an expected value at which the listed item is bought and may determine a credit. When having determined a credit at such a timing, the credit provision module 1623 may update the credit stored in the trade management data 1626 and update the credit total in the user management data 1625.

For example, when the item is listed, the credit provision module 1623 may determine a credit based on easiness to sell (selling easiness of) the predetermined listed item on the electronic trade platform, which is specified based on, for example, the market price of the listed item and/or the scarcity of the listed item. For example, when the listed price of the listed item is lower than the market price, the probability that the listed item is sold is high, and thus the credit provision module 1623 may set a higher credit rate. When the listed price of the listed item is higher than the market price but the scarcity of the listed item is high, the probability that the listed item is sold is high, and thus the credit provision module 1623 may set a higher credit rate.

When the credence score of the listing user is high, the probability that the listed item is traded is high or the reliability that the listing user repays a debt is high, and thus the credit provision module 1623 may determine a larger credit as the credence score of the listing user is higher. This credit setting may be automatically determined by the server 110A or the server 110B or may be set by the first user.

Accordingly, a credit can be more flexibly determined based on the reliability that the listing user repays a debt.

When the market price or scarcity of the listed item or the credence score has changed after listed, the credit provision module 1623 may redetermine a credit total. The server 110A may determine the market price and scarcity of the listed item and easiness to sell the predetermined listed item on the electronic trade platform based on current or past trade data in the trade management data 1626.

When an action is performed on the listed item from the terminal 120 used by another purchase candidate user, the credit provision module 1623 may determine a credit based on the action. More specifically, a credit may be determined based on the number of actions. Examples of the action include browse of a listed item page, bookmark registration of the listed item, and comment provision to the listed item. The probability that the listed item is sold is higher as the number of times of browse of the listed item page, the number of times of bookmark registration, or the number of comments is larger, and thus the credit provision module 1623 may set a higher credit rate. A credit may be determined based on a ratio of the number of times of browse of the listed item page, the number of times of bookmark registration of the listed item, or the number of comments provided to the listed item. More specifically, when the ratio of the number of times of bookmark registration of the listed item or the number of comments provided to the listed item relative to the number of times of browse of the listed item page is large, the credit may be set to be higher than when the ratio is low. This is because it can be estimated that a large number of users highly intend to purchase the listed item when the ratio of the number of times of bookmark registration of the listed item or the number of comments provided to the listed item relative to the number of times of browse of the listed item page is large.

The credit provision module 1623 may determine the credit based on the contents of comments. For example, the probability that the listed item is sold is high when comments on the listed item include keywords, such as “swiftly . . . ” and “thank you”, which frequently appear right before the listed item is sold, and thus the credit provision module 1623 may set a higher credit rate.

Since a credit is provided for a listed item, the credit provision module 1623 may cancel the credit provided for the listed item when the listed item is traded or when the listing is canceled. When an identical item is listed in a predetermined duration after listing of the listed item is canceled, the credit provision module 1623 may determine that a credit is not provided based on the listed item. In this case, the credit provision module 1623 may determine whether the canceled listed item and the newly listed item are identical based on the similarity between the canceled listed item and the newly listed item. In addition, when listing of a listed item related to credit provision is canceled after determination of the credit provision, the credit provision module 1623 may execute processing of reducing the credence score of the listing user.

Accordingly, a loan can be avoided from being provided based on a credit provided based on an unlisted item. In addition, the risk that listing intended for credit provision is performed for cancellation can be reduced. Moreover, when an identical item is listed in a predetermined duration after listing of a listed item is canceled, the credit provision module 1623 may permit a predetermined number of times of listing to prevent excessive restriction of credit provision on false listing due to a false operation or the like.

When having acquired a request for a loan within the credit total of the first user from the terminal 120A used by the listing user, the loan management module 1624 executes processing of providing the loan to the listing user in accordance with the loan request. For example, the loan management module 1624 sets a loan ID for each loan request and stores information related to the loan, such as a listed item ID and a repayment condition corresponding to the amount of the loan and a used credit, in loan management data 1627. Accordingly, the listing user can collectively receive the loan in the credit total as the sum of credits for a plurality of listed items.

The loan management module 1624 may loan a predetermined fund from a predetermined account to an account of the listing user through an external system operated by another business operator such as a financial institution, or may provide a loan to the listing user by issuing a money equivalent usable on the electronic trade platform.

In particular, when a loan is executed in the form of currency or points usable on the electronic trade platform, a loaned fund can be caused to be used in the electronic trade platform. Accordingly, electronic trade in the electronic trade platform can be further activated through the loan.

When providing a loan, the loan management module 1624 may place a repayment condition on the listing user. For example, a day after elapse of a predetermined duration since a day on which the loan is provided may be specified as a repayment day, or repayment of part or all of the amount of the loan from the sale proceeds of a listed item for which a credit is provided may be specified.

Through the above-described processing, the listing user can receive a loan based on a credit provided for a listed item. In addition, as a benefit of an administrator of the electronic trade platform, it is possible to increase the number of listings from users for loans. Moreover, since a loan is provided based on a credit provided for a listed item, it is possible to perform bond collection directly or indirectly from the sale proceeds of the listed item. Thus, the risk that a bond on the administrator of the electronic trade platform cannot be collected can be reduced.

The credit provision module 1623 may calculate, for example, a price sum of a plurality of listed items listed by the listing user and determine a credit by multiplying the price sum by a predetermined credit rate. Calculation of the listed price sum or the market price sum may be limited to listed items listed in a predetermined duration. In this case as well, the timing of credit determination and the method of credit determination may be same as those described above.

Accordingly, the credit can be provided when the prices of individual listed items listed by the listing user are low and the credit cannot be sufficiently provided with one listed item alone.

When having provided a loan to the listing user, the loan management module 1624 may perform, for some or all listed items listed by the listing user, as a collateral of the loan, listing cancellation and/or processing of restricting the amount of increase and decrease of the prices of the listed items. The amount of increase and decrease of the listed prices may be permitted in a predetermined money amount or a predetermined money amount ratio. In addition, when all or part of the amount of the loan is repaid by the listing user, the loan management module 1624 may remove listing cancellation and/or restriction on the amount of increase and decrease of prices of the listed items. When applying or removing such a restriction, the loan management module 1624 may store information related to the restriction in the trade management data 1626.

Accordingly, the listing user having received the loan can be prevented from disappearing with the loan by, for example, canceling a listed item, and thus the risk that bond collection becomes impossible can be reduced for the administrator of the electronic trade platform.

When providing a loan to the listing user, the loan management module 1624 may perform processing of requesting, as a collateral of the loan, storage of some or all listed items listed by the listing user at a facility managed by the electronic trade platform and sensing storage of the listed items. In addition, when all or part of the amount of the loan is repaid by the listing user, the loan management module 1624 may perform processing of receiving a return request for returning the listed items stored at the facility back to the listing user. When storing or returning the listed items in this manner, the loan management module 1624 may store information related to the storage or return in the trade management data 1626.

When a loan is provided as described above, a listed item under management of the listing user is placed under management of the electronic trade platform, thereby reducing the risk that the listed item is not traded because, for example, the listing user does not ship the listed item to a purchase user. Thus, the risk that bond collection becomes impossible can be reduced for the administrator of the electronic trade platform.

When a listed item is traded, the loan management module 1624 may execute processing of allotting part or all of the sale proceeds of the listed item to repayment of a loan.

Accordingly, bond collection can be performed when the listing user acquires sale proceeds, and thus the risk that bond collection becomes impossible can be reduced for the administrator of the electronic trade platform. In addition, the listing user can easily proceed debt repayment procedure and thus reduce work of repayment.

The storage 163 stores, for example, a program executed by the server 110A according to the second embodiment, the user management data 1625 with which a user as a member of the electronic trade platform is managed, the trade management data 1626 with which a trade executed on the electronic trade platform is managed, and the loan management data 1627. These data will be described later.

One or a plurality of processors 161 read and execute each module from the memory 162 as necessary. For example, the one or plurality of processors 161 may achieve a listing management unit, a credit provision unit, and a loan management unit by executing the listing management module 1622, the credit provision module 1623, and the loan management module 1624, respectively.

### (2) Configuration of Terminal 120

FIG. 10 is an exemplary block diagram illustrating the configuration of the terminal 120 according to the second embodiment. The terminal 120 is a terminal used by a listing user or a purchase user on the electronic trade platform. The terminal 120 includes, for example, a display control module 1422, a trade processing module 1423, and a loan request module 1424. Each processing may be achieved by machine learning or artificial intelligence (AI) as long as it is possible.

Each module disclosed in FIG. 10 is achieved through cooperation of a processor 141, a memory 142, a storage 143, an input-output I/F 144, an input device 145, an output device 146, and a transmission-reception unit 147, which are included in the terminal 120. For example, the display control module 1422, the trade processing module 1423, and the loan request module 1424 can be each achieved by the processor 141 reading and executing a program stored in the storage 143.

In FIG. 10, the processor 161, the memory 162, the storage 163, the input-output I/F 164, the input device 165, the output device 166, and the transmission-reception unit 167 correspond to the processor 111, the memory 112, the storage 113, the input-output I/F 114, the input device 115, the output device 116, and the transmission-reception unit 117, respectively.

The trade processing module 1423 executes processing related to an electronic trade. For example, the trade processing module 1423 executes, as a listing user side, processing of registering item information and processing of performing negotiation on a listed item with a purchase user. The trade processing module 1423 executes, as a purchase user side, processing of browsing a listed item, selecting a listed item, and instructing payment.

The loan request module 1424 executes processing of requesting the server 110A for a loan based on a credit total provided for a listed item listed on the listing user side. For example, in response to an operation by the listing user, the loan request module 1424 accesses user management data at the server 110A and browses information of the credit total. In response to an operation by the user, the loan request module 1424 may transmit a request for display of a listing list to the server 110A, acquire, from the server 110A, a listing list in which a listed item and the credit total provided for the listed item are displayed in association with each other, and control screen display of the listing list.

Subsequently, in response to an operation by the user, the loan request module 1424 transmits a loan request in the range of the credit total to the server 110A. In this case, the loan request module 1424 may transmit, to the server 110A, the amount of a requested loan as well as information related to a listed item provided with a credit used for the loan.

Accordingly, for example, when listed item A and listed item B are listed, the listing user can select a listed item on which a restriction such as listing cancellation is placed as described above. Thus, convenience of listed item management for the listing user is further improved.

The storage 143 stores a program executed by the terminal 120 according to the second embodiment. The storage 143 may store, for example, programs for executing processing that is related to an electronic trade and used by a listing user and a purchase user and processing that assists loan and debt repayment and is used by the listing user. The program for executing processing that is related to an electronic trade and the program for executing processing that assists loan and debt repayment may be programs different from each other.

One or a plurality of processors 141 read and execute each module from the memory 142 as necessary. For example, the one or plurality of processors 141 may achieve a display control unit, a trade processing unit, and a loan request unit by executing the display control module 1422, the trade processing module 1423, and the loan request module 1424.

### Exemplary Data

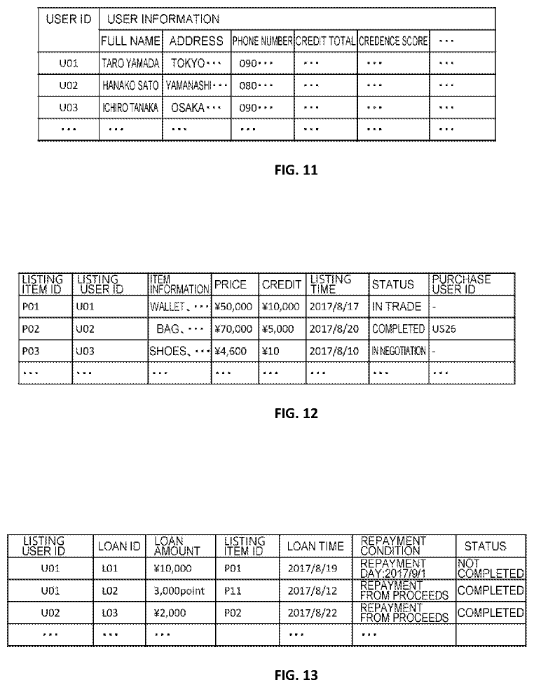

Data at the server 110A will be described below with reference to FIGS. 11 to 13.

FIG. 11 illustrates exemplary user management data according to the second embodiment. The user management data manages information related to each member user on the electronic trade platform. The “user ID” includes user identification information for the server 110A to uniquely identify a user. The “user information” includes personal information of the user, such as “full name”, “address”, and “phone number”. The “credit total” may include information related to the sum of credits that the user has. The “credence score” is an index that indicates creditworthiness of the user.

FIG. 12 illustrates exemplary trade management data 1126 according to the second embodiment. The “listed item ID” includes identification information for the server 110A to uniquely identify a listed item. The “listing user ID” includes the user ID of a listing user. The “item information” includes the item name and description of the listed item and other information related to the listed item. The “money amount” includes the listed price of the listed item determined by the listing user. The “credit” includes a credit determined for the listed item by the credit provision module 1623 of the server 110A. The “listing time” includes a time at which the item is listed. The “status” includes the state of a trade in an electronic trade. The status includes “in trade” indicating that the listed item is currently in trade, “in negotiation” indicating that the trade is in negotiation with a purchase user, and “completed” indicating that the listed item is sold. The “purchase user ID” includes the user ID of a user having bought the listed item.

FIG. 13 illustrates exemplary loan management data 1627 according to the second embodiment. The “loan ID” includes identification information for the server 110A to uniquely identify a loan. The “listing user ID” includes the user ID of a listing user having requested a loan. The “loan amount” includes the amount of a loan provided in response to the loan request. The “listed item ID” includes the listed item ID of a listed item provided with a credit total used when the loan is requested. The “loan time” includes a time at which the loan is provided. The “repayment condition” includes the day and method of repayment. The “status” includes the state of the loan in an electronic trade. The status includes “completed” indicating that the repayment is completed, and “not completed” indicating that the repayment is yet to be completed.

The memory 142 may store, in association with the user ID, account information such as electronic values and points possessed by the user.

### Operation Processing of Second Embodiment

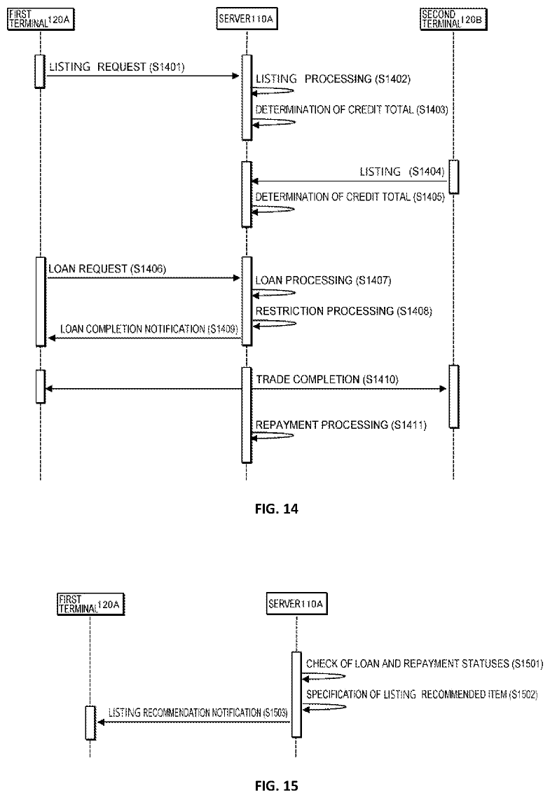

The following describes processing by the trade system 1 according to the second embodiment with reference to FIG. 14. FIG. 14 illustrates an exemplary sequence of the processing by the trade system 1 according to the second embodiment. In the exemplary sequence illustrated in FIG. 14, the terminal 120A is a terminal through which a listing user registers item information and requests a loan, and the terminal 120B is a terminal used by a purchase user.

(Step S1401)

In accordance with an operation by the listing user, the transmission-reception unit 147 of the terminal 120A transmits item information and the price of a listed item as well as a listing request for the listed item to the server 110A. The item information includes, for example, image information of the listed item and the name of the listed item.

(Step S1402)

The listing management module 1122 of the server 110A executes processing of listing the listed item for which the listing request is received. For example, the transmission-reception unit 167 of the server 110A receives the listing request, the item information, and the price of the listed item, and the listing management module 1122 sets a listing ID in accordance with the listing request and stores information related to the listed item in the trade management data 1126. The listing management module 1122 of the server 110A releases the item information and the price on the electronic trade platform so that the item information and the price can browsed by an optional user.

(Step S1403)

The credit provision module 1623 of the server 110A determines a credit provided for the listed item and stores the credit in the trade management data 1126. For example, the credit is determined based on the listed item market price of a category to which the listed item belongs and/or the scarcity of the listed item. More specifically, a credit rate may be calculated based on, for example, an expected value at which the listed item is sold, based on the difference between the price of the listed item and the listed item market price and/or the scarcity of the listed item, and the credit may be set to be a value obtained by multiplying the price of the listed item by the credit rate. Alternatively, the credit may be directly determined based on the price of the listed item without using the credit rate. The credit determination may result in determination that no credit is provided. When the credit is determined based on the difference between the price of the listed item and the listed item market price, the credit rate in a case in which the price of the listed item is lower than the listed item market price may be set to be higher than the credit rate in a case in which the price of the listed item is higher than the listed item market price.

(Step S1404)

The listing management module 1122 of the server 110A receives an action through the transmission-reception unit 167 from the terminal 120B used by a purchase candidate user of the listed item. Examples of the action include browse of a listed item page, bookmark registration of the listed item, and comment provision to the listed item. The listing management module 1122 stores information related to the action, such as the number of times of browse of the listed item page, the number of times of bookmark registration of the listed item, the number of comments, and/or the contents of comments, in the trade management data 1126.

(Step S1405)

The credit provision module 1623 of the server 110A determines a credit based on the action stored in the trade management data 1126 and stores the credit in the trade management data 1126. In this case, a credit total stored in the trade management data 1126 in the past may be updated to a credit total in which the credit determined at step S1405 is added.

(Step S1406)

In accordance with an operation by the listing user, the loan request module 1424 of the terminal 120A transmits, to the server 110A, a request for a loan together with the amount of the loan and a listed item ID having a credit used for the loan. In this case, consensus formation on a repayment method and a repayment condition of the loan may be performed between the loan request module 1424 of the terminal 120A and the loan management module 1624 of the server 110A.

(Step S1407)

The loan management module 1624 of the server 110A executes processing related to the loan in accordance with the loan request. For example, the transmission-reception unit 167 of the server 110A receives the loan request and information related to the loan, such as the loan amount, and the loan management module 1624 sets a loan ID in accordance with the loan request and stores information related to the loan in the loan management data 1627. Then, the loan management module 1624 executes the loan. For example, the loan management module 1624 may loan a predetermined fund from a predetermined account to an account of the listing user through an external system operated by another business operator such as a financial institution, or may execute the loan by issuing currency or points usable on the electronic trade platform.

(Step S1408)

The loan management module 1624 of the server 110A may perform, for a listed item corresponding to a listed item ID stored in the loan management data 1627, listing cancellation and/or processing of restricting the amount of increase and decrease of the price of the listed item.

(Step S1409)

The loan management module 1624 of the server 110A instructs the transmission-reception unit 167 to transmit, to the listing user, a notification that the loan is completed.

(Step S1410)

The listing management module 1122 of the server 110A mediates the listing user and a purchase user and executes processing of trading the listed item. The listing management module 1122 can trade the listed item by executing processing provided by a well-known electronic trade platform.

(Step S1411)

The loan management module 1624 of the server 110A executes processing of allotting part or all of the sale proceeds of the listed item to repayment of the loan. For example, in a case of payment in an electronic value, the amount of the electronic value corresponding to the amount of a credit provided for the listed item can be subtracted from the balance of the account of the listing user, thereby achieving bond collection.

Example

An example of the second embodiment is an example in which information related to repayment of a loan as well as a notification that recommends listing of a listed item suitable for the repayment are transmitted to a listing user to which the loan is provided.

Effects of Example

According to the example, repayment can be assisted by prompting a listing user to which a loan is provided to listing a listed item, and the risk that bond collection becomes impossible can be reduced for the administrator of the electronic trade platform.

Configuration of Example

In the following description, a component same as that in the second embodiment is denoted by the same reference sign, and description thereof is omitted. Description of operations and effects same as those of the second embodiment is also omitted. The description is mainly made on difference from the second embodiment.

In the present example, the loan management module 1624 of the server 110A executes processing of transmitting a notification that recommends listing of a listed item to a listing user to which a loan is provided. From a viewpoint of loan repayment, the notification that recommends listing of a listed item may include market information of an item included in a list of items possessed by the listing user, and information of a listed item that is likely to be traded.

The listing management module 1622 may produce the list of items possessed by the listing user by extracting, from the trade management data 1626, an item that the listing user has bought by using the electronic trade platform but has not sold. The listing management module 1622 may receive unlisted information related to an unlisted item from the terminal 120 of the listing user and may produce the list of items possessed by the listing user based on the unlisted information. In this case, the listing management module 1622 may store information related to the possessed item list in the user management data 1625.

Operation Processing of Example

The following describes processing by the trade system 1 according to the example with reference to FIG. 15.

In the example, processing up to step S1409 at which the loan processing is performed may be same as that in the second embodiment. Step S1501 is a step after the loan processing is performed. At step S1501, the loan management module 1624 of the server 110A refers to the loan management data 1627 and checks loan and repayment statuses of a listing user to which a loan is provided. In this case, the loan management module 1624 specifies a remaining repayment amount.

At step S1502, the loan management module 1624 of the server 110A specifies information related to a listed item that the listing user is recommended to listing. For example, the loan management module 1624 specifies market information of an item included in the possessed item list of the listing user and the traded number thereof. Accordingly, the market information that is useful for price setting at listing and the traded number as an index that evaluates easiness to purchase a listed item can be obtained for an item possessed by the listing user.

The loan management module 1624 may refer to the trade management data 1626 and specify a listed item category for which the traded number is larger and market information thereof, a listed item category for which the duration from listing to purchase is short and market information thereof, and the like as well as an item included in the possessed item list of the listing user. Such information related to a listed item is information of a listed item that is likely to be sold when listed.

At step S1503, the loan management module 1624 of the server 110A instructs the transmission-reception unit 167 to collect information related to each listed item that the listing user is recommended to listing, and to transmit the information to the terminal 120A.

Through the above-described processing, listing can be promoted by a notification of an item included in the possessed item list of the listing user and information related to a listed item that is likely to be sold. As the listing user obtains a larger amount of sale proceeds through listing, opportunity for bond collection increases for the administrator of the electronic trade platform, and the risk that bond collection becomes impossible can be reduced.

In the above description, the description was made in the form of delay of repayment of a debt associated with the listing user is permitted based on the listed price or market price of a listed item and the credence score of the listing user. A configuration related to the credence score is optional. More specifically, delay of repayment of a debt associated with the listing user may be permitted based on the listed price or market price of a listed item without using the credence score.

As described above, the present invention is not limited to the above-described embodiments and examples but may be modified in various manners without departing from the scope of the present invention. In other words, the above-described embodiments are merely exemplary and not to be interpreted in a restrictive manner.

What is claimed is:

1. An information processing method executed by an information processing device including one or a plurality of processors, wherein the one or plurality of processors execute:
processing of acquiring a listing request for a listed item from a first information processing device used by a first user;
processing of listing the listed item; and
processing of permitting delay of repayment of a debt associated with the first user based on a listed price or market price of the listed item.

2. The information processing method according to claim 1, wherein the processing of permitting delay of repayment includes processing of permitting delay of repayment of the debt associated with the first user based on the listed price or market price of the listed item and a credence score of the first user.

3. The information processing method according to claim 1, wherein the processing of permitting delay of repayment includes processing of determining the number of days by which the debt is to be delayed and/or a debt amount in which the debt is to be delayed.

4. The information processing method according to claim 1, wherein the processing of permitting delay of repayment includes processing of determining, based on an action from a second user, the number of days by which the debt is to be delayed and/or a debt amount in which the debt is to be delayed.

5. The information processing method according to claim 4, wherein the action includes at least one of browse of a page of the listed item, bookmark registration of the listed item, and comment provision to the listed item.

6. The information processing method according to claim 2, wherein the processing of permitting delay of repayment includes processing of determining, based on the credence score, the number of days by which the debt is to be delayed and/or a debt amount in which the debt is to be delayed.

7. The information processing method according to claim 6, further comprising processing of determining, as the credence score is higher, a larger number of days by which the debt is to be delayed and/or a larger debt amount in which the debt is to be delayed.

8. The information processing method according to claim 1, wherein the one or plurality of processors further execute processing of canceling the permission of delay of repayment when the listing of the listed item is canceled.

9. The information processing method according to claim 1, wherein the one or plurality of processors further execute processing of allotting at least part of sale proceeds of the listed item to repayment of debt associated with the first user when the listed item is traded.

10. The information processing method according to claim 9, wherein the processing of allotment to repayment of the debt includes allotting sale proceeds of the listed item to repayment of a debt on a nearest repayment day on or later than a day on which the listed item is traded.

11. An information processing device including one or a plurality of processors, wherein the one or plurality of processors execute:
processing of acquiring a listing request for a listed item from a first information processing device used by a first user;
processing of listing the listed item; and
processing of permitting delay of repayment of a debt associated with the first user based on a listed price or market price of the listed item.

12. An information processing method executed by an information processing device including one or a plurality of processors, wherein the one or plurality of processors execute:
processing of acquiring a listing request for a listed item from a first information processing device used by a first user;
processing of listing the listed item; and
processing of adding a credit determined based on the listed price or market price of the listed item and a credence score of the first user to a credit total associated with the first user.

13. The information processing method according to claim 12, wherein the processing of addition to the credit total includes processing of determining the credit based on an action from a second user on the listed item.

14. The information processing method according to claim 13, wherein the processing of addition to the credit total includes processing of determining the credit based on the number of actions from the second user.

15. The information processing method according to claim 13, wherein the action includes at least one of browse of a page of the listed item, bookmark registration of the listed item, and comment provision to the listed item.

16. The information processing method according to claim 12, further comprising processing of determining the credit to be larger as the credence score is higher.

17. The information processing method according to claim 12, wherein the one or plurality of processors further execute processing of canceling the credit when the listing of the listed item is canceled.

18. The information processing method according to claim 12, wherein the one or plurality of processors further execute:
processing of acquiring, from the first user, a request for a loan within the credit total of the first user provided for the listed item; and
processing of providing the loan to the first user in accordance with the request for the loan.

19. The information processing method according to claim 18, wherein the processing of providing the loan includes processing of providing the loan in a money equivalent that is usable on an electronic trade platform.

20. The information processing method according to claim 18, wherein the one or plurality of processors further execute processing of allotting at least part of sale proceeds of the listed item to repayment of the loan when the listed item is traded.
